(19) United States
(12) Patent Application Publication
(10) Pub. No.: US 2015/0376940 A1
(43) Pub. Date: Dec. 31, 2015

(54) ADJUSTMENT DEVICE FOR ADJUSTING DISTANCE OF OBSERVATION SPACE OF WINDOW BLINDS

(71) Applicant: CHING FENG HOME FASHIONS CO., LTD, Fuxing Shiang (TW)

(72) Inventors: SHENG-YING HSU, Fuxing Shiang (TW); CHUN JAN HSU, Fuxing Shiang (TW)

(21) Appl. No.: 14/723,156

(22) Filed: May 27, 2015

(30) Foreign Application Priority Data
Jun. 25, 2014 (TW) 103211194

(51) Int. Cl. E06B 9/322; E06B 9/388; E06B 9/326

(52) U.S. Cl. CPC E06B 9/322; E06B 9/326; E06B 9/388; E06B 2009/3222

(57) ABSTRACT

A window blinds includes a head box, a top bar, a bottom bar and a blind body connected between the top and bottom bars. A first fixed seat and a second fixed seat are respectively located in the head box, each of the first and second fixed seats is cooperated with a movable seat and a spring which is connected between the first/second fixed seat and the head box. Two first cords are wrapped between the first fixed seat and the movable seat corresponding thereto, and are connected to the top bar. Two second cords are wrapped between the second fixed seat and the movable seat corresponding thereto, and extend through the head box, the blind body and are connected to the bottom bar. A stop member is connected to the two first cords and located between the positioning post and the first knot to adjust the size of the observation space.

### BACKGROUND OF THE INVENTION

1. Fields of the invention

The present invention is a Continuation-In-Part application of U.S. Pat. No. 7,487,817, filed on Jun. 9, 2006.

2. Descriptions of Related Art

U.S. Pat. No. 7,487,817 discloses a non-pull cord operable window blind structure which has a fixed seat and a movable seat located in the head box, an operational cord is wrapped between the fixed seat and the movable seat. The operational cord is cooperated with a lift cord which extends through the blind body and is connected to the bottom bar connected to the lower end of the blind body. By moving the bottom bar, the movable seat is moved to scroll or release the lift cord to lift or lower the blind body. The blind body can be positioned at desired position by the force balance of the operational cord and the lift cord.

U.S. patent application Ser. No. 14/242,894 discloses an improved structure of the connection between the movable seat and the fixed seat by using a spring to replace the complicated structure disclosed in U.S. Pat. No. 7,487,817. The spring is connected between the movable seat and the head box.

Another window blinds is developed to have a head box, a top bar and a bottom bar, wherein the blind body is connected between the top bar and the bottom bar. An observation space can be formed between the head box and the top bar so that the users in the room can observe movements outside the room from the observation space without interference by the slats. There are even number of lift cords connected between the top bar and the bottom bar such that the top bar can be moved away from the head box to form the observation space. However, the size of the observation space cannot be adjusted.

The present invention intends to provide an adjustment device of window blinds wherein the size of the observation space between the head box and the top bar can be adjusted.

### SUMMARY OF THE INVENTION

The present invention relates to an adjustment device for window blinds, and comprises a head box, a top bar, a bottom bar and a blind body. The blind body is connected between the top bar and the bottom bar which is connected to the lower end of the blind body. The top bar is movably located beneath the head box.

The head box has a first fixed seat and a second fixed seat located therein, and each of the first and second fixed seats is cooperated with a movable seat and a spring. The head box has two holes defined through the bottom board thereof. Each of the two springs has a first end connected to the head box, and a second end connected to the movable seat. The first fixed seat and the movable seat corresponding thereto are located at the first end of the head box, and the second fixed seat and the movable seat corresponding thereto are located at the second end of the head box. The first and second fixed seats each have multiple positioning posts.

Two first cords are wrapped between the first fixed seat and the movable member corresponding to the first fixed seat. A first knot is connected two respective first ends of the two first cords and the first knot is positioned outside of one of the positioning posts of the first fixed seat. Two respective second ends of the two first cords respectively extend through the holes and are connected to the top bar.

Two second cords are wrapped between the second fixed seat and the movable member corresponding to the second fixed seat. A second knot is connected two respective first ends of the two second cords and the second knot is fixed to one of the positioning posts of the second fixed seat. Two respective second ends of the two second cords respectively extend through the holes, the blind body and are connected to the bottom bar.

A stop member is connected to the two first cords and in contact with the positioning post and located between the positioning post and the first knot.

The primary object of the present invention is to provide an adjustment device of window blinds, and more particularly, to an adjustment device for controlling the size of the observation space between the head box and the top bar of the window blinds.

Another object of the present invention is to provide an adjustment device of window blinds, wherein a stop member is connected to a desire position of the first cords to control the size of the observation space between the head box and the top bar of the window blinds.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the adjustment device of the present invention;

FIG. 2A is a top view of the adjustment device of the present invention;

FIG. 2B is a front view of the adjustment device of the present invention;

FIG. 3 is an enlarged view of the first fixed seat of the adjustment device of the present invention;

FIG. 4A is a top view of the adjustment device of the present invention, wherein the top bar is moved;

FIG. 4B is a front view of the adjustment device of the present invention, wherein the top bar is moved;

FIG. 5A is a top view to show that the stop member is used to adjust the first cords;

FIG. 5B is a front view to show that the stop member is used to adjust the first cords;

FIG. 6A is a top view to show the adjustment device in the head box wherein the blind body is lowered;

FIG. 6B is a front view to show the adjustment device in the head box wherein the blind body is lowered;

FIG. 7A is a top view to show the adjustment device in the head box wherein the blind body is collected and the observation space is formed;

FIG. 7B is a front view to show the adjustment device in the head box wherein the blind body is collected and the observation space is formed;

FIG. 8A is a top view to show the adjustment device in the head box wherein the blind body is expanded and the observation space is formed, and

FIG. 8B is a front view to show the adjustment device in the head box wherein the blind body is expanded and the observation space is formed.

### DETAILED DESCRIPTION OF THE PREFERRED EMBODIMENT

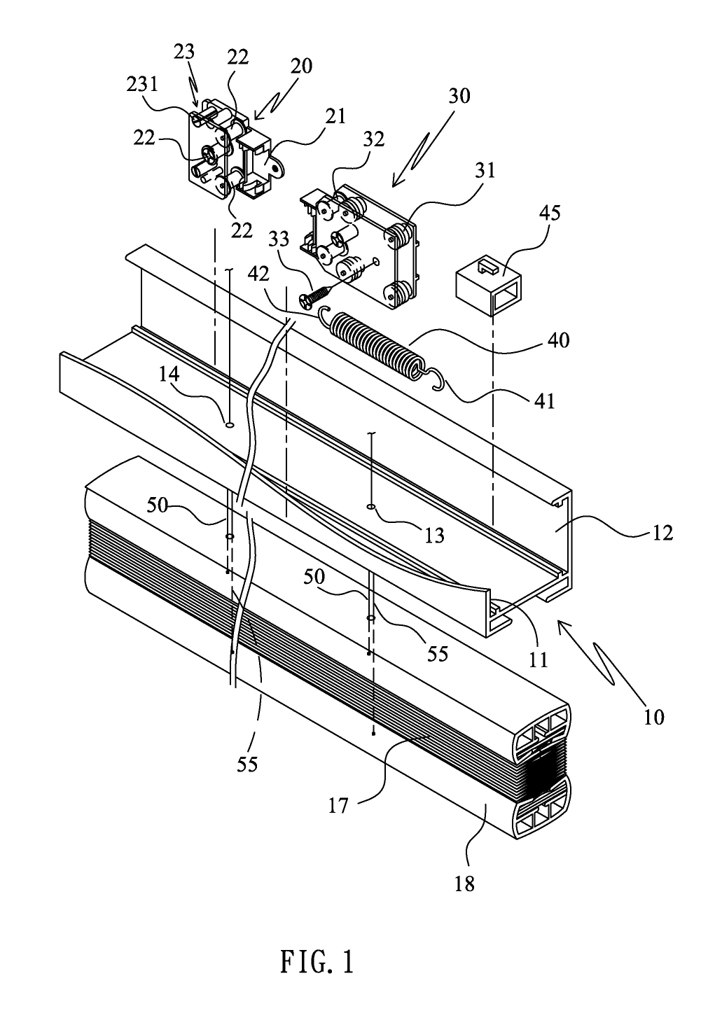

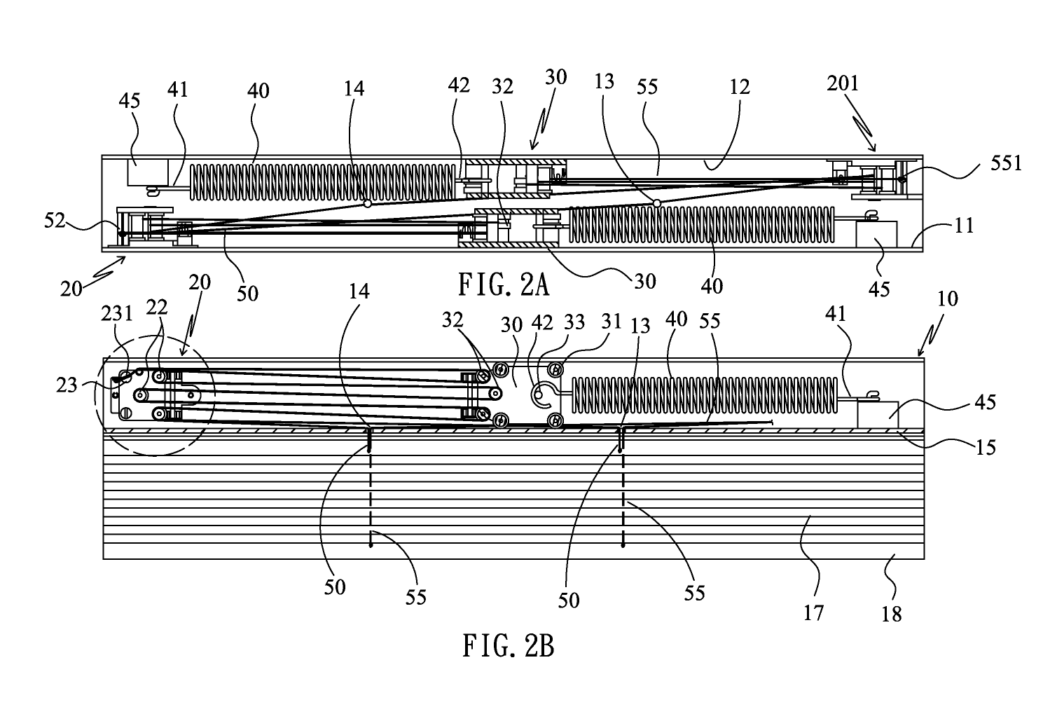

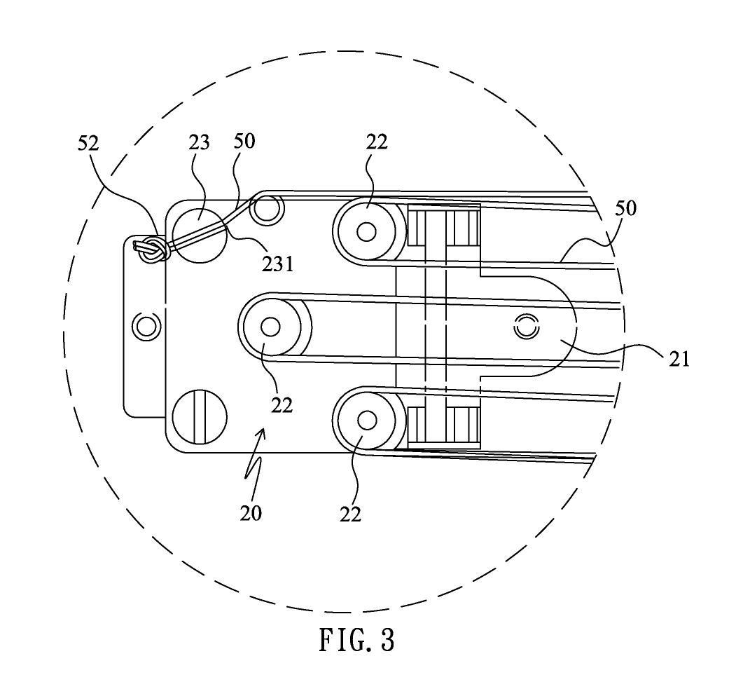

Referring to FIGS. 1, 2A, 2B, the adjustment device of the present invention comprises a head box 10, a top bar 15, a bottom bar 18 and a blind body 17. The blind body 17 is connected between the top bar 15 and the bottom bar 18 which is connected to a lower end of the blind body 17. The top bar 15 is movably located beneath the head box 10. The head box 10 has a U-shaped end cross section and has a first end and a second end.

A first fixed seat 20 and a second fixed seat 201 are respectively located in the first end and the second end of the head box 10. Each of the first and second fixed seats 20, 201 is cooperated with a movable seat 30 and a spring 40. In detail, the head box 10 has a first sidewall 11 and a second sidewall 12 which is parallel to the first sidewall 11 and located at a distance from the first sidewall 11. The head box 10 has two holes 13, 14 defined through the bottom board thereof. The first fixed seat 20 and the movable seat 30 corresponding to the first fixed seat 20 are connected to the first sidewall 11. The second fixed seat 201 and the movable seat 30 corresponding to the second fixed seat 201 are connected to the second sidewall 12. Each of the two springs 40 has a first end 41 connected to the head box 10, and a second end 42 connected to the movable seat 30. In detail, the first end 41 of each of the springs 40 is fixed to a fixed member 45 which is fixed to the head box 10. Each of the two movable seats 30 has a bolt 33 connected thereto, and the second end 42 of each of the two springs 40 is hooked to the bolt 33. The first fixed seat 20 and the movable seat 30 corresponding thereto located at the first end of the head box 10, and the second fixed seat 201 and the movable seat 30 corresponding thereto located at the second end of the head box 10.

The first and second fixed seats 20, 201 are identical and comprises two plates, a fixed end 21 extends from one end of each of the first and second fixed seats 20, 201 and is fixed to the head box 10. Each of the first and second fixed seats 20, 201 has multiple positioning posts 23 connected between the two plates thereof. Multiple first posts 22 are connected between two plates of each of the first fixed seat 20 and the second fixed seat 201. Multiple second posts 32 are connected to each of the two movable seats 30. The first cords 50 are wrapped between the first posts 22 of the first fixed seat 20 and the second posts 32 of the movable seat 30 corresponding to the first fixed seat 20. Two second cords 55 are wrapped between the first posts 22 of the second fixed seat 201 and the second posts 32 of the movable seat 30 corresponding to the second fixed seat 201.

A first knot 52 is connected two respective first ends of the two first cords 50 and the first knot 52 is positioned outside of one of the positioning posts 23 of the first fixed seat 20. Two respective second ends of the two first cords 50 respectively extend through the holes 13, 14 of the head box 10 and are connected to the top bar 15.

A second knot 551 is connected two respective first ends of the two second cords 55 and the second knot 551 is fixed to one of the positioning posts 23 of the second fixed seat 201. Two respective second ends of the two second cords 55 respectively extend through the holes 13, 14 of the head box 10, the blind body 17 and are connected to the bottom bar 18.

Each of the positioning posts 23 of each of the first and second fixed seats 20, 201 has a slit 231. The two first cords 50 extend through the slit 231 of one of the positioning posts 23 of the first fixed seat 20, and the first knot 52 is located outside of the positioning post 23. The two second cords 55 extend through the slit 231 of one of the positioning posts 23 of the second fixed seat 201, and the second knot 551 is located outside of the positioning post 23. It is noted that the size of each of the first knot 52 and the second knot 551 is larger than that of the slit 231, such that the first/second cords 50/55 do not pass through the slit 231 and are separated from the positioning post 23.

Each of the two movable seats 30 has multiple rollers 31. The rollers 31 on the movable seat 30 corresponding to the first fixed seat 20 roll on the first sidewall 11. The rollers 31 on the movable seat 30 corresponding to the second fixed seat 201 roll on the second sidewall 12.

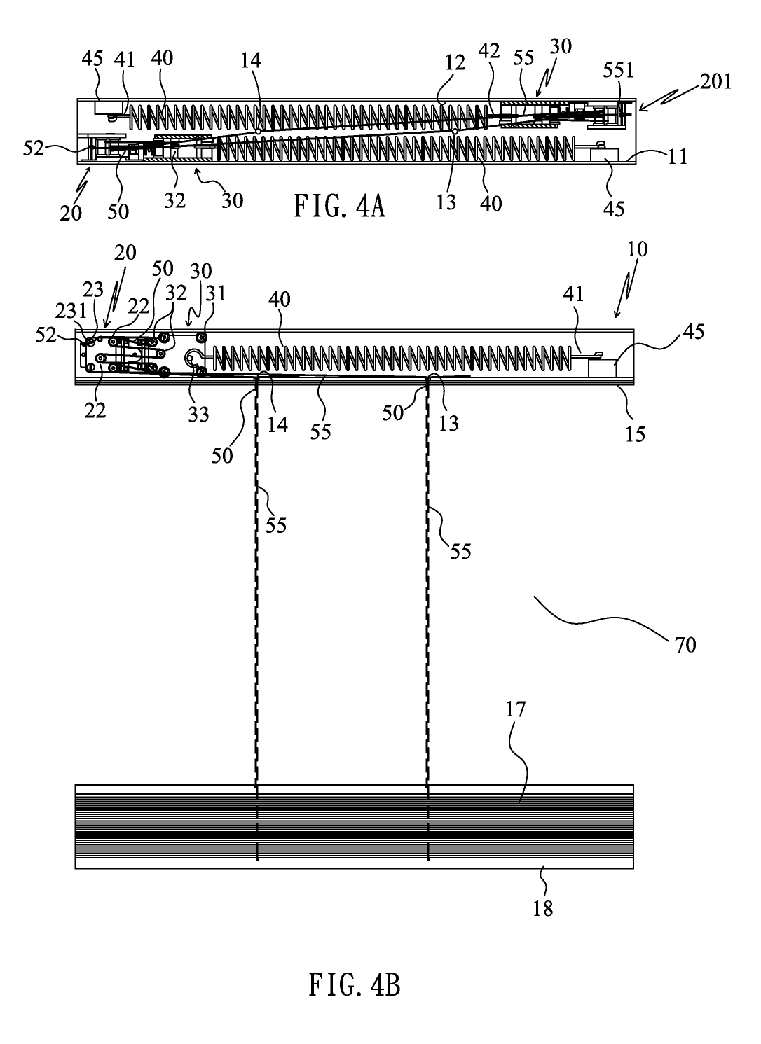

As shown in FIGS. 4A and 4B, when the blind body 17 is not expanded, the user operates the top bar 15 and the bottom bar 18 to change the tension of the first cords 50 and the second cords 55. Therefore, the two movable seats 30 are moved to respectively contact the first and second fixed seats 20, 201 so that the first cords 50 and the second cords 55 are completely released. The top bar 15 and the blind body 17 are moved toward the bottom bar 18, so that an observation space 70 is formed between the head box 10 and the top bar 15.

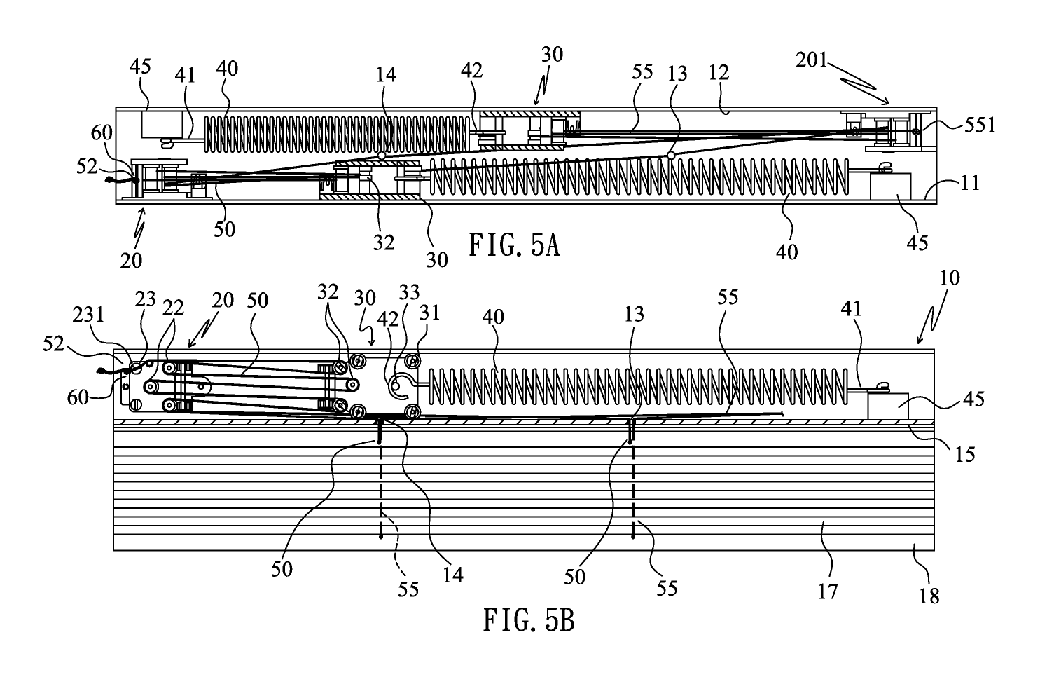

As shown in FIGS. 5A and 5b, when the top bar 15 is not removed from the head box 10, and the blind body 17 is not yet expanded, the user holds the first knot 52 and pulls a section of the first cords 50 beyond the slit 21. A stop member 60 is then connected to the two first cords 50 and in contact with the positioning post 23 and located between the positioning post 23 and the first knot 52. In this embodiment, the stop member 60 is a knot and the outer diameter of the stop member 60 is larger than the size of the slit 231 so that the first cords 50 cannot be pulled backward by the spring 40. Therefore, the length of the first cords 50 that is wrapped between the first fixed seat 20 and the movable seat 30 is shortened.

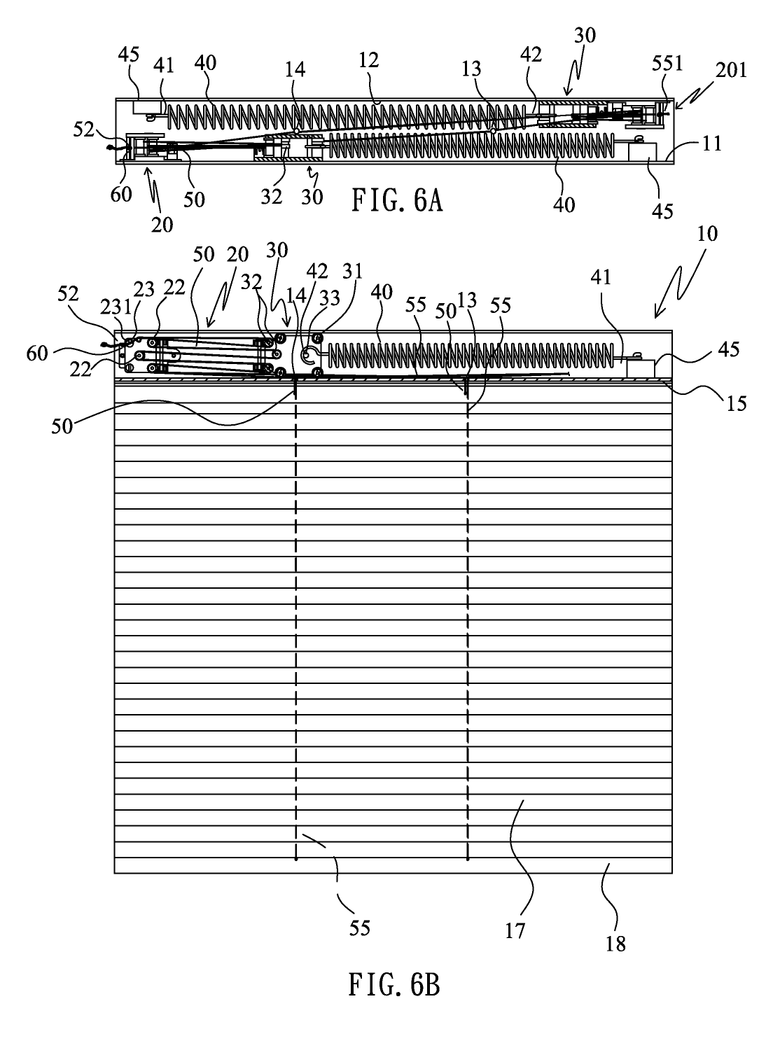

As shown in FIGS. 6A, 6B, the adjustment of the first cords 50 as shown in FIG. 5B by using the stop member 60 does not affect the second cords 55. Therefore, when pulls the bottom bar 18, the movable seat 30 corresponding to the second fixed seat 201 is moved so that the second cords 55 is released such that the bottom bar 18 is lowered and the blind body 17 is expanded. The first fixed seat 20 and the movable seat 30 corresponding to the first fixed seat 20 are located at the position disclosed in FIGS. 5A, 5B.

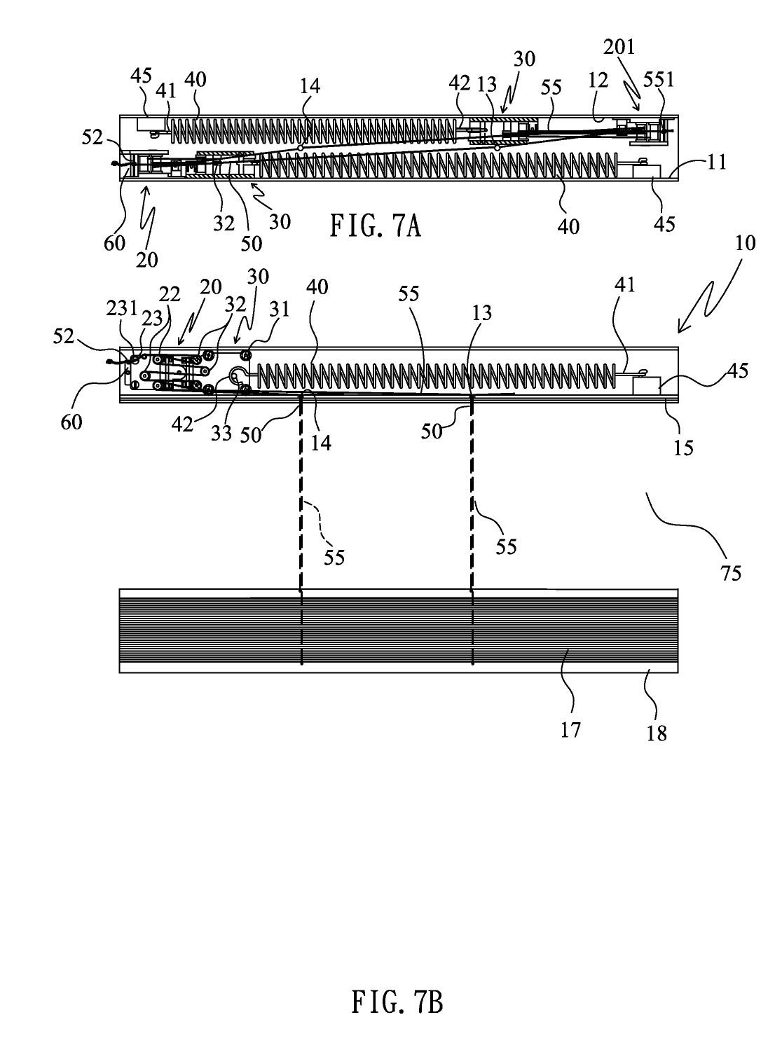

As shown in FIGS. 7A, 7B, when the top bar 15 is pushed away from the bottom bar 18 under the status in FIGS. 5A, 5B, the first cords 50 are released from the movable seat 30 which moves in the head box 10. When the movable seat 30 contacts the first fixed seat 20, the movement of the first cords 50 stop. The observation space 75 between the head box 10 and the top bar 15 is smaller than the observation space 70 in FIG. 4B. This is because the stop member 60 shortens the length of the first cords 50 in the first fixed seat 20. In this status, the bottom bar 18 is not lowered and the blind body 17 is not expanded. The positions of the second fixed seat 201 and the movable member 30 corresponding thereto are different from those of the first fixed seat 20 and the movable member 30 corresponding thereto.

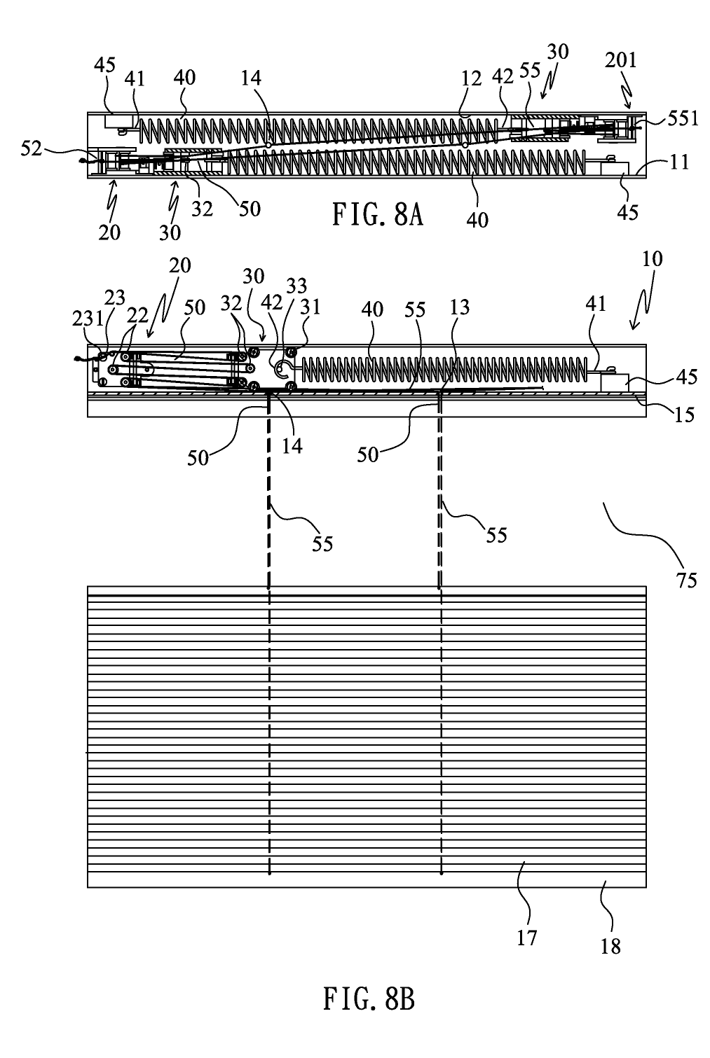

FIGS. 8A, 8B show that under the status disclosed in FIGS. 5A and 5B, pushing the bottom bar 18 downward to move the second cords 55, the movable member 30 corresponding to the second fixed seat 201 moves toward the second fixed seat 201. The bottom bar 18 is lowered, and the second cords 55 are released and the blind body 17 is expanded. Even when the blind body 17 is completely expanded, the size of the observation space 75 is not changed.

While we have shown and described the embodiment in accordance with the present invention, it should be clear to those skilled in the art that further embodiments may be made without departing from the scope of the present invention.

What is claimed is:

1. An adjustment device for window blinds, comprising:
a head box, a top bar, a bottom bar and a blind body, the blind body connected between the top bar and the bottom bar which is connected to a lower end of the blind body, the top bar movably located beneath the head box;
the head box having a first fixed seat and a second fixed seat located therein, each of the first and second fixed seats being cooperated with a movable seat and a spring 40, the head box having two holes defined through a bottom board thereof, each of the two springs having a first end connected to the head box, and a second end connected to the movable seat, the first fixed seat and the movable seat corresponding thereto located at a first end of the head box, the second fixed seat and the movable seat corresponding thereto located at a second end of the head box, the first and second fixed seats each having multiple positioning posts;
two first cords wrapped between the first fixed seat and the movable seat corresponding to the first fixed seat, a first knot connected two respective first ends of the two first cords and the first knot being positioned outside of one of the positioning posts of the first fixed seat, two respective second ends of the two first cords respectively extending through the holes of the head box and connected to the top bar;
two second cords wrapped between the second fixed seat and the movable seat corresponding to the second fixed seat, a second knot connected two respective first ends of the two second cords and the second knot fixed to one of the positioning posts of the second fixed seat, two respective second ends of the two second cords respectively extending through the holes of the head box, the blind body and connected to the bottom bar, and
a stop member connected to the two first cords and being in contact with the positioning post and located between the positioning post and the first knot.

2. The device as claimed in claim 1, wherein the head box has a first sidewall and a second sidewall which is parallel to the first sidewall and located at a distance from the first sidewall, the first fixed seat and the movable seat corresponding to the first fixed seat are connected to the first sidewall, the second fixed seat and the movable seat corresponding to the second fixed seat are connected to the second sidewall.

3. The device as claimed in claim 1, wherein the first end of each of the springs is fixed to a fixed member which is fixed to the head box.

4. The device as claimed in claim 1, wherein the first and second fixed seats are identical, a fixed end extends from one end of each of the first and second fixed seats and is fixed to the head box, multiple first posts are connected between two plates of each of the first and second fixed seats, multiple second posts are connected to each of the two movable seats, the first cords are wrapped between the first posts of the first fixed seat and the second posts of the movable seat corresponding to the first fixed seat 20, the second cords are wrapped between the first posts of the second fixed seat and the second posts of the movable seat corresponding to the second fixed seat, each of the two movable seats has multiple rollers, the rollers on the movable seat corresponding to the first fixed seat roll on the first sidewall, the rollers on the movable seat corresponding to the second fixed seat roll on the second sidewall.

5. The device as claimed in claim 1, wherein each of the two movable seats has a bolt connected thereto, the second end of each of the two springs is hooked to the bolt.

6. The device as claimed in claim 1, wherein each of the positioning posts of each of the first and second fixed seats has a slit, the two first cords extend through the slit of one of the positioning posts of the first fixed seat, the two second cords extend through the slit of one of the positioning posts of the second fixed seat, a size of each of the first knot and the second knot is larger than that of the slit.

7. The device as claimed in claim 6, wherein a size of the stop member is larger than that of the slit.

8. The device as claimed in claim 1, wherein the stop member is a knot.
